(19) United States
(12) Patent Application Publication
(10) Pub. No.: US 2013/0033520 A1
(43) Pub. Date: Feb. 7, 2013

(54) IMAGE GENERATING DEVICE, IMAGE GENERATING METHOD, AND NON-TRANSITORY INFORMATION STORAGE MEDIUM

(71) Applicants: Masanobu Tanaka, Kanagawa (JP); Fumito Ueda, Tokyo (JP); Hajime Sugiyama, Kanagawa (JP); Naofumi Ito, Tokyo (JP); Ryoma Matsuya, Kanagawa (JP); Toshihiro Kamei, Tokyo (JP)

(72) Inventors: Masanobu Tanaka, Kanagawa (JP); Fumito Ueda, Tokyo (JP); Hajime Sugiyama, Kanagawa (JP); Naofumi Ito, Tokyo (JP); Ryoma Matsuya, Kanagawa (JP); Toshihiro Kamei, Tokyo (JP)

(73) Assignee: SONY COMPUTER ENTERTAINMENT INC., Tokyo (JP)

(21) Appl. No.: 13/557,504

(22) Filed: Jul. 25, 2012

(30) Foreign Application Priority Data
Aug. 1, 2011 (JP) 2011-168176

(51) Int. Cl. G09G 5/00

(52) U.S. Cl. 345/619

(57) ABSTRACT

Provided is an image generating device including: a section for acquiring an arrangement of elements constituting an object with respect to a frame to be processed; an arrangement correction section including a control section and plurality of partial correction sections, for correcting an arrangement of each of the elements; and an image rendering section for rendering an image based on the arrangement of the elements corrected by the arrangement correction step. The plurality of partial correction sections respectively correct the arrangement of at least one of the plurality of elements, and the control section provides control so that at least one of the plurality of partial correction section corrects the arrangement of the elements based on the control data, which associates a state of the object and at least two of the plurality of partial correction sections, and on the state of the object.

### CROSS-REFERENCE TO RELATED APPLICATION

The present application claims priority from Japanese application JP2011-168176 filed on Aug. 1, 2011, the content of which is hereby incorporated by reference into this application.

### BACKGROUND OF THE INVENTION

1. Field of the Invention

The present invention relates to an image generating device, an image generating method, and an information storage medium.

2. Description of the Related Art

There is a technology for generating in real time a three-dimensional image representing a motion of an object in accordance with an input of a user. When the image is generated, a motion of an object determined in advance is reproduced based on a state of the object determined by the input of the user or the like, or the motion of the object is generated by a program.

When a motion determined in advance is reproduced, or a motion is simply generated by a program, only an image for a predetermined situation can be generated, and it is difficult to flexibly express a motion of the object in accordance with a change in state.

### SUMMARY OF THE INVENTION

The present invention has been made in view of the above-mentioned problem, and therefore has an object to provide a technology capable of flexibly expressing a motion of an object in accordance with a change in state of the object.

In order to solve the above-mentioned problem, according to an exemplary embodiment of the present invention, there is provided a computer-readable non-transitory information storage medium having stored thereon a program for controlling a computer to function as arrangement acquisition means for acquiring an arrangement of each of elements constituting an object with respect to a frame to be processed; arrangement correction means including control means and a plurality of partial correction means, for correcting an arrangement of each of the elements; and image rendering means for rendering an image based on the arrangement of each of the elements corrected by the arrangement correction means. The plurality of partial correction means respectively correct the arrangement of at least one of the plurality of elements, and the control means provides control so that at least one of the plurality of partial correction means corrects the arrangement of each of the elements based on control data, which associates a state of the object and at least two of the plurality of partial correction means, and on the state of the object.

According to an exemplary embodiment of the present invention, there is also provided an image generating device, including: arrangement acquisition means for acquiring an arrangement of each of elements constituting an object with respect to a frame to be processed; arrangement correction means including control means and a plurality of partial correction means, for correcting an arrangement of each of the elements; storing means for storing control data associating a state of the object and at least two of the plurality of partial correction means with each other; and image rendering means for rendering an image based on the arrangement of each of the elements corrected by the arrangement correction means, in which: the plurality of partial correction means respectively correct the arrangement of at least one of the plurality of elements; and the control means provides control so that at least one of the plurality of partial correction means corrects the arrangement of each of the elements based on the control data and the state of the object.

According to an exemplary embodiment of the present invention, there is further provided an image generating method, including:

an arrangement acquisition step of acquiring an arrangement of each of elements constituting an object with respect to a frame to be processed; an arrangement correction step including a control step and a plurality of partial correction steps to correct an arrangement of each of the elements; and an image rendering step of rendering an image based on the arrangement of each of the elements corrected in the arrangement correction step, in which: the plurality of partial correction steps respectively include correcting the arrangement of at least one of the plurality of elements; and the control step includes providing control so that the arrangement of each of the elements is corrected in at least one of the plurality of partial correction steps based on control data, which associates a state of the object and at least two of the plurality of partial correction steps, and on the state of the object.

According to the present invention, it is possible to flexibly express a motion of an object in accordance with a change in state of the object.

According to the exemplary embodiment of the present invention, the computer may be further controlled to function as parameter acquisition means for acquiring at least one of a plurality of parameters corresponding to any one of the plurality of the partial correction means based on a positional relationship between the object and another object. Each of the plurality of partial correction means may correct at least one of the plurality of elements based on the acquired parameter corresponding to the partial correction means.

Further, according to the exemplary embodiment of the present invention, the parameter acquisition means may acquire the parameter in accordance with the at least one of the partial correction means which the control means controls to correct the arrangement.

Further, according to the exemplary embodiment of the present invention, the parameter acquisition means may acquire the parameter each time a frame to be processed changes.

### BRIEF DESCRIPTION OF THE DRAWINGS

In the accompanying drawings:

FIG. 1 is a diagram illustrating an example of a configuration of an image generating device according to an embodiment of the present invention;

FIG. 2 is a diagram illustrating functional blocks of the image generating device according to the embodiment of the present invention;

FIG. 3 is a diagram illustrating an example of an arrangement of each of skeletons contained in a certain object;

FIG. 4 is a flowchart illustrating an example of a process flow of the image generating device according to the embodiment of the present invention;

FIG. 5 is a flowchart illustrating an example of a process flow of an arrangement correction section;

FIG. 6 is a table showing an example of control data;

FIG. 7 is a flowchart illustrating an example of a process flow by one partial correction section;

FIG. 8 is a diagram illustrating an example of a corrected arrangement of each of the skeletons;

FIG. 9 is a diagram illustrating another example of a corrected arrangement of each of the skeletons; and

FIG. 10 is a diagram illustrating functional blocks of an editing device for generating motion data and the partial correction section.

### DETAILED DESCRIPTION OF THE INVENTION

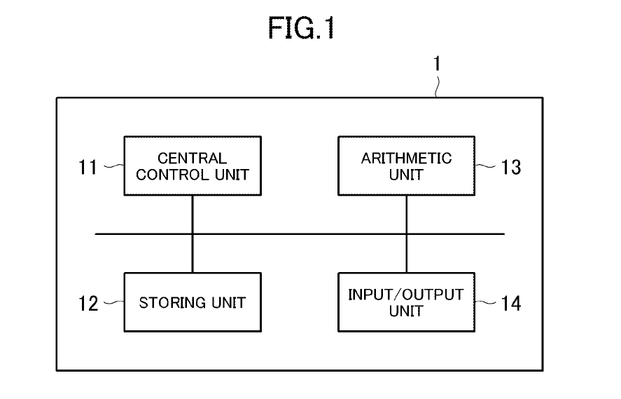

Hereinafter, an embodiment of the present invention is described with reference to the accompanying drawings. FIG. 1 is a diagram illustrating a configuration of an image generating device 1 according to the embodiment of the present invention. The image generating device 1 includes a central control unit 11, a storing unit 12, an arithmetic unit 13, and an input/output unit 14. The image generating device 1 is a device having a function of generating a three-dimensional image, as exemplified by a personal computer or a consumer game machine.

The central control unit 11 operates in accordance with a program stored in the storing unit 12 and controls the arithmetic unit 13 and the input/output unit 14. Note that, the above-mentioned program may be provided by being stored in a computer-readable information storage medium such as a DVD-ROM, or may be provided via a network such as the Internet.

The storing unit 12 includes a memory element such as a RAM or a ROM, a hard disk drive, and the like. The storing unit 12 stores the above-mentioned program. The storing unit 12 also stores information input from the respective units and operation results.

The arithmetic unit 13 has a function of performing arithmetic operation such as floating-point calculation at high speed. The arithmetic unit 13 operates in accordance with the program stored in the storing unit 12 and outputs the calculation result to the storing unit 12 and the input/output unit 14. Note that, which of the central control unit 11 or the arithmetic unit 13 is controlled to carry out each of parts of arithmetic processing may be arbitrarily determined in accordance with characteristics of the part of the processing when the program is produced.

The input/output unit 14 includes means for controlling a display output device such as a monitor, means for controlling an input device such as a mouse, and the like. The input/output unit 14 outputs image data and the like to the display output device and acquires information from an operator (user) through the input device under control of the central control unit 11.

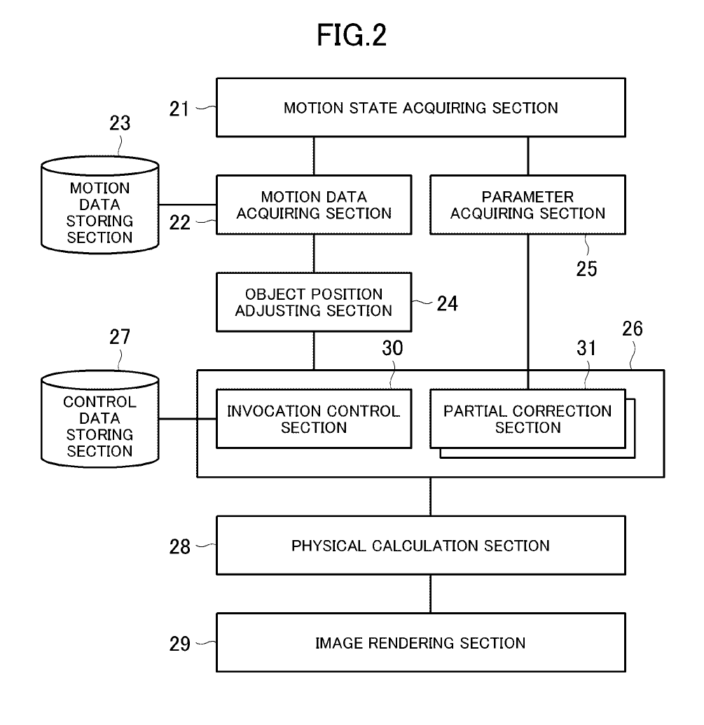

FIG. 2 is a diagram illustrating functional blocks of the image generating device 1 according to the embodiment of the present invention. The image generating device 1 functionally includes a motion state acquiring section 21, a motion data acquiring section 22, a motion data storing section 23, an object position adjusting section 24, a parameter acquiring section 25, an arrangement correction section 26, a control data storing section 27, a physical calculation section 28, and an image rendering section 29. Further, the arrangement correction section 26 functionally includes an invocation control section 30 and partial correction sections 31. Those functions are implemented by the central control unit 11 and the arithmetic unit 13 executing the program stored in the storing unit 12 and controlling the input/output unit 14.

The motion data storing section 23 is implemented mainly by the storing unit 12. The motion data storing unit 23 stores motion data for an object (object 40) to be rendered for each type of motion.

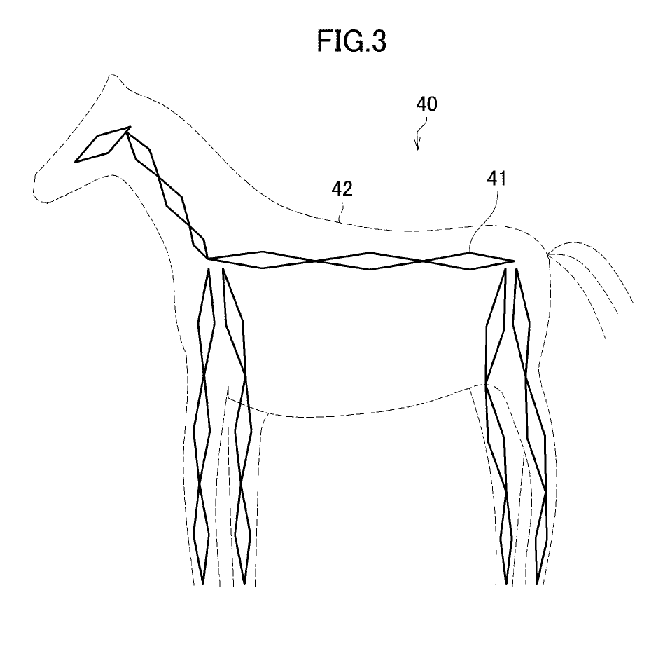

FIG. 3 is a diagram illustrating an example of an arrangement of each of skeletons 41 contained in a certain object 40. The object 40 contains a plurality of skeletons 41, a plurality of skin meshes 42 representing a surface of the object 40, and a plurality of ragdolls which are not illustrated. The skeletons 41, the ragdolls, and the like are types of element constituting the object 40. Each of the skin meshes 42 is a polygon including a plurality of vertices, and the skin meshes 42 are disposed so as to enclose the surface of the object 40. The skeleton 41 corresponds to a framework of the object 40 for which an image is to be generated, and each of the skeletons 41 has a relationship of connection with other skeletons 41. Moreover, coordinates of vertices of the skin mesh 42 are determined in accordance with arrangements of the skeletons 41. In other words, a shape of the surface of the object 40 is determined by the arrangements of the skeletons 41. The rag doll is a rigid body subject to a physical simulation. The ragdoll and the skeleton 41 correspond to each other on a one-to-one basis.

The motion data is data representing a motion of the object 40 to be rendered for a corresponding type of motion. Specifically, the data representing the motion of the object 40 is information on arrangements (positions, directions, and sizes) of the skeletons 41 constituting the object 40, the information being stored for each frame. One frame is each of a plurality of divisions of a period in which the motion is carried out, and a time interval between the neighboring frames may be constant, or may be variable in consideration of a processing load and the like. The arrangements of the skeletons 41 represent reference arrangements, and the image is generated based on arrangements corrected by processing described later. FIG. 3 illustrates arrangements of respective skeletons 41 in a certain frame when the type of motion is “standing”.

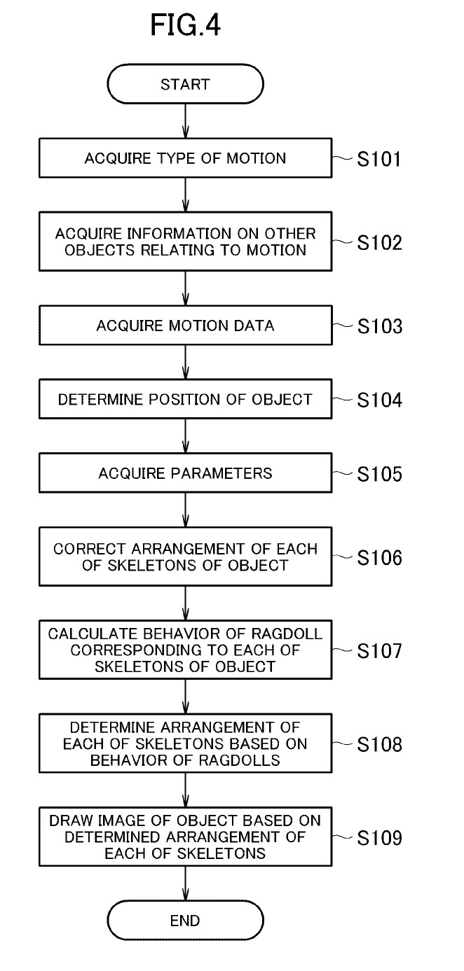

FIG. 4 is a flowchart illustrating an example of a process flow of the image generating device 1 according to the embodiment of the present invention. A description is now given of functions of the image processing device 1 according to the process flow. Note that, this process flow represents processing in a certain frame (frame to be processed), and the processing is repeated each time the frame changes.

The motion state acquiring section 21 is implemented mainly by the central control unit 11, the storing unit 12, and the input/output unit 14. The motion state acquiring section 21 acquires the type of motion, which is a kind of the state of the object 40 (hereinafter, also referred to as “object of interest” if the object 40 is need to be distinguished from other objects) to be rendered in the frame to be processed, based on information input by a user via the input/output unit 14, a positional relationship to another object 40, and the like (Step S101). On this occasion, the type of motion of the object of interest includes “walking”, “standing”, and “sitting”. As an example of the positional relationship to the another object 40 includes whether or not the closest object 40 such as another animal or human in the previous frame is within a predetermined range, or whether or not there is a collision against an object 40 such as a wall.

The motion state acquiring section 21 then acquires information on other objects 40 relating to the motion (Step S102). For example, when the type of motion of the object of interest is “standing”, the information on other objects 40 relating to the motion may be information on a position of an object 40 of food existing in a neighborhood, and when the type of motion of the object of interest is “walking”, the information on other objects 40 relating to the motion may be information on an object 40 being a destination.

The motion data acquiring section 22 is implemented mainly by the central control unit 11, and the storing unit 12. The motion data acquiring section 22 acquires motion data in the frame to be processed from the motion data storing section 23 (Step S103). More specifically, the motion data acquiring section 22 acquires information on an arrangement of each of the skeletons 41 in the frame to be processed. The arrangement of the skeleton 41 acquired on this occasion is an arrangement of the skeleton 41 under a specific condition used as a reference such as a condition in which the object of interest is fixed on a plane and a direction of a head is fixed in a certain direction. A description is now given of processing of correcting the arrangements of the skeletons 41 based on a terrain of a position at which the object of interest is disposed or information on objects 40 relating to the motion, such as an obstacle on a floor.

The object position adjusting section 24 is implemented mainly by the central control unit 11, the storing unit 12, and the arithmetic unit 13. The object position adjusting section 24 determines a position of a travel destination of the object 40 (Step S104). For example, the object position adjusting section 24 determines a position of the object of interest in the frame to be processed when the object of interest is walking toward an object 40 being a destination, or a position of the object of interest where the head of the object of interest reaches a food when the object of interest is standing while eating the food.

The parameter acquiring section 25 is implemented mainly by the central control unit 11, and the storing unit 12. The parameter acquiring section 25 acquires at least one of a plurality of parameters for the frame to be processed (Step S105). Each of the plurality of parameters corresponds to any one of partial correction sections 31, and is information to be passed to the partial correction section 31. The parameter acquiring section 25 may acquire information on a position of a food, for example, acquired by the motion state acquiring section 21 as a parameter of a position toward which the object of interest is expected to move the head. Moreover, the parameter acquiring section 25 may calculate a position which a foot of the object of interest touches based on a position of the travel destination determined by the object position adjusting section 24, and may acquire the calculation result as a parameter. In the calculation of the position which the foot of the object of interest touches, the parameter acquiring section 25 performs the calculation so as to avoid an obstacle such as a stone present under the object of interest at the travel destination, for example. On this occasion, this processing is carried out for each frame, and the parameter acquiring section 25 acquires the parameter each time the frame to be processed changes.

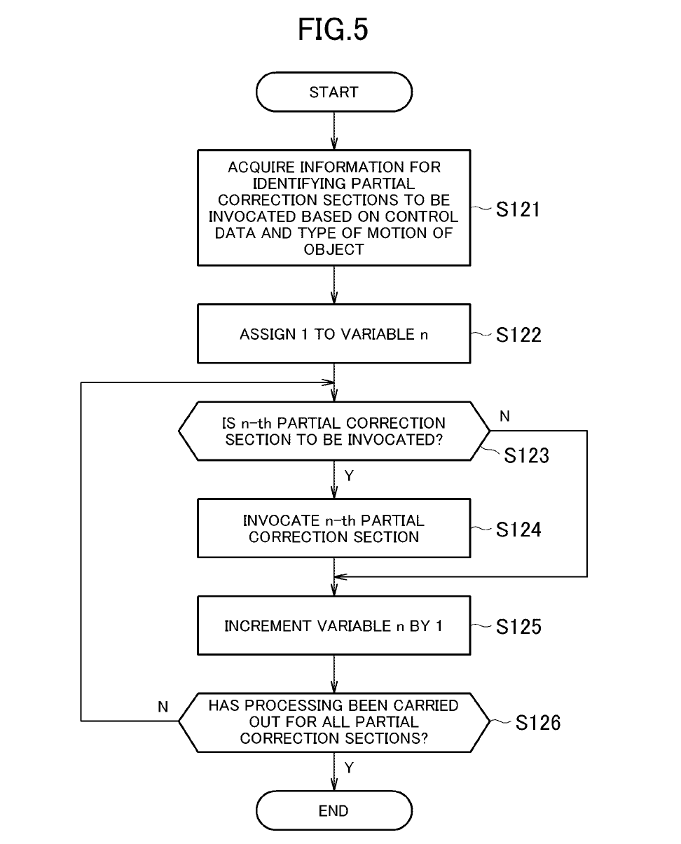

The arrangement correction section 26 is implemented mainly by the central control unit 11, the storing unit 12, and the arithmetic unit 13. The arrangement correction section 26 corrects the arrangement of each of the skeletons 41 constituting the object 40 (Step S106). A detailed description is now given of the processing by the arrangement correction section 26. FIG. 5 is a flowchart illustrating an example of a process flow of the arrangement correction section 26.

The invocation control section 30 is implemented mainly by the central control unit 11, and the storing unit 12. The invocation control section 30 provides control so that a part of the plurality of partial correction sections 31 corrects the arrangements of respective skeletons 41 based on control data and the state of the object 40. Moreover, the control data storing section 27 stores the control data associating the state of the object 40 and at least two of the plurality of the partial correction sections 31. Each of the partial correction sections 31 is implemented mainly by the central control unit 11, the storing unit 12, and the arithmetic unit 13, and the respective partial correction sections 31 correct the arrangements of at least a part of the plurality of skeletons 41. The plurality of partial correction sections 31 are provided in order to correct the arrangements of the skeletons 41 constituting the one object 40.

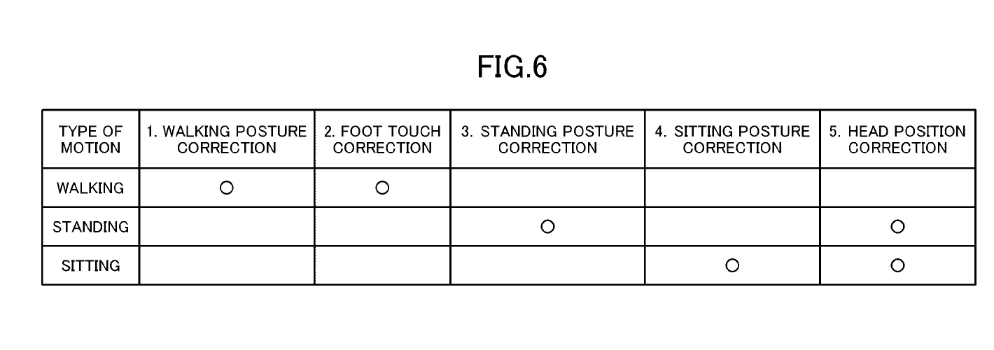

First, the invocation control section 30 acquires information for identifying partial correction sections 31 to be invocated based on the control data and the type of motion of the object 40 (Step S121). FIG. 6 is a table showing an example of the control data. The control data represents each of combinations between the type of motion and the partial correction sections 31, and each row of the table in FIG. 6 corresponds to the type of motion, and each column of the table corresponds to the partial correction section 31. FIG. 6 shows that the type of motion “walking” corresponds to a first partial correction section 31 for carrying out “walking posture correction” and a second partial correction section 31 for carrying out “foot touch correction”, the type of motion “standing” corresponds to a third partial correction section 31 for carrying out “standing posture correction” and a fifth partial correction section 31 for carrying out “head position correction”, and the type of motion “sitting” corresponds to a fourth partial correction section 31 for carrying out “sitting posture correction” and the fifth partial correction section 31.

For example, when the type of motion acquired by the motion state acquiring section 21 is “standing”, the invocation control section 30 acquires “third” and “fifth” as information for identifying the partial correction sections 31 to be invocated. On this occasion, the control data is associated with a plurality of partial correction sections 31 for a predetermined type of motion, and the associated partial correction sections 31 are part of the entire partial correction sections 31.

Then, the invocation control section 30 assigns 1 to a variable n (Step S122), and when an n-th partial correction section 31 is a partial correction section 31 to be invocated (Y in Step S123), the n-th partial correction section 31 is invocated by using a parameter for this partial correction section 31 (Step S124). Moreover, the parameter thereof is of course acquired by the parameter acquiring section 25. When the n-th partial correction section 31 is not a partial correction section 31 to be invocated (N in Step S123), the invocation control section 30 skips the processing of Step S124. Then, the invocation control section 30 increments the variable n by 1 (Step S125), and confirms whether the processing of Step S123 has been carried out for all the partial correction sections 31 (Step S126). When the processing has been carried out for all the partial correction sections 31 (Y in Step S126), the processing by the invocation control section 30 is finished, and when the processing has not been carried out for all the partial correction sections 31 (N in S126), the invocation control section 30 repeats the processing starting from Step S123.

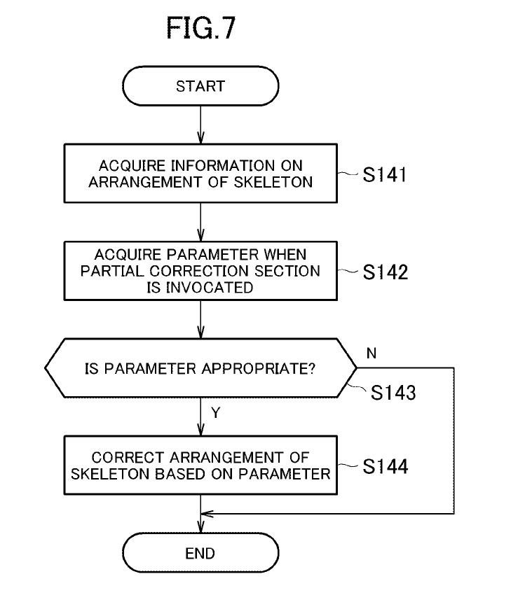

On this occasion, a description is now given of processing of the partial correction section 31 invocated by the invocation control section 30. FIG. 7 is a flowchart illustrating an example of a process flow by one partial correction section 31. The partial correction section 31 invocated along with a parameter by the invocation control section 30 first acquires information on an arrangement of each skeleton 41 which was acquired by the motion data acquiring section 22, and has been corrected by the processing carried out by the object position adjusting section 24, other partial correction sections 31, and the like (Step S141). Moreover, the partial correction section 31 acquires the parameter when the partial correction section 31 itself is invocated (Step S142). Then, the partial correction section 31 confirms whether or not the acquired parameter is appropriate for correcting the arrangement (Step S143), and when the parameter is appropriate (Y in Step S143), the partial correction section 31 corrects arrangements of at least a part of the skeletons 41 based on the parameter (Step S144). When the parameter is not appropriate (N in Step S143), the processing by this partial correction section 31 is finished, and the processing is returned to the invocation control section 30. The processing in Step S143 prevents unnecessary processing such as moving the head from being carried out in such a case where there is nothing for the head to approach, and the parameter is thus not set accordingly.

Correction of the arrangement (position and direction) of the skeleton 41 is acquired by the following processing, for example. First, the partial correction section 31 applies an FK-IK conversion to data for forward kinematics (FK) representing the arrangement of the skeleton 41, thereby generating coordinates of a point (corresponding to an end of a certain skeleton 41) to be used for inverse kinematics (IK) control. Then, the partial correction section 31 changes the coordinate in accordance with the parameter. Then, the partial correction section 31 acquires the arrangement of each skeleton 41 determined by the change by carrying out the IK-FK conversion. The processing corrects positions of at least a part of the respective skeletons 41.

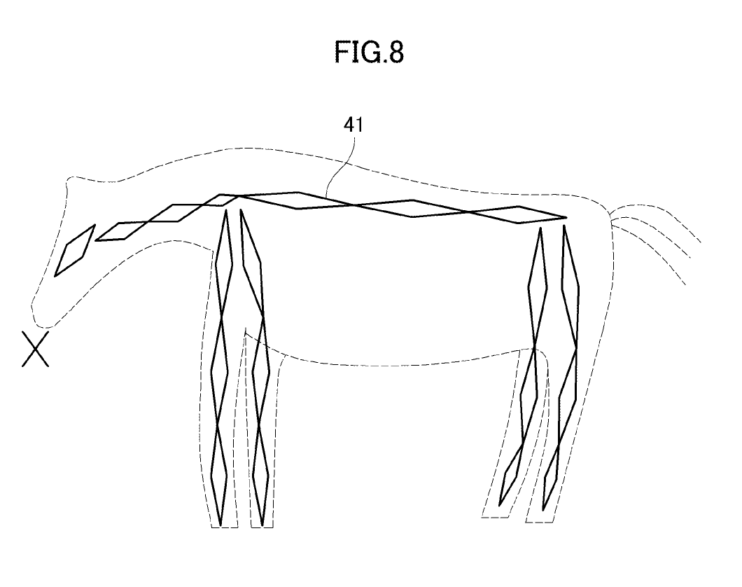

FIG. 8 is a diagram illustrating an example of a corrected arrangement of each of the skeletons 41. FIG. 8 illustrates an example in which the arrangements of the skeletons 41 illustrated in FIG. 3 are corrected. Across mark in FIG. 8 represents a position which is provided as a parameter, and which the head is to approach. First, the third partial correction section 31 which carries out “standing posture correction” determines that a position which the head is to approach is provided as a parameter, and calculates a distance between a target position and a position of a point in a skeleton 41 corresponding to a rump and a distance between the target position and a position of a point in a skeleton 41 corresponding to a shoulder. Then, the position of the point in the skeleton 41 corresponding to the rump and the position of the point in the skeleton 41 corresponding to the shoulder are changed in accordance with the distances, and arrangements of the skeleton 41 corresponding to the spine and the skeletons 41 corresponding to the feet are accordingly corrected. Then, the fifth partial correction section 31 which carries out “head position correction” corrects skeletons 41 corresponding to the head and the neck, in accordance with the position of the shoulder and a position which the head is to approach. As a result, it is possible to flexibly combine various correction methods, namely to flexibly represent a motion of the object in accordance with the state of the objects 40 such as the type of the motion.

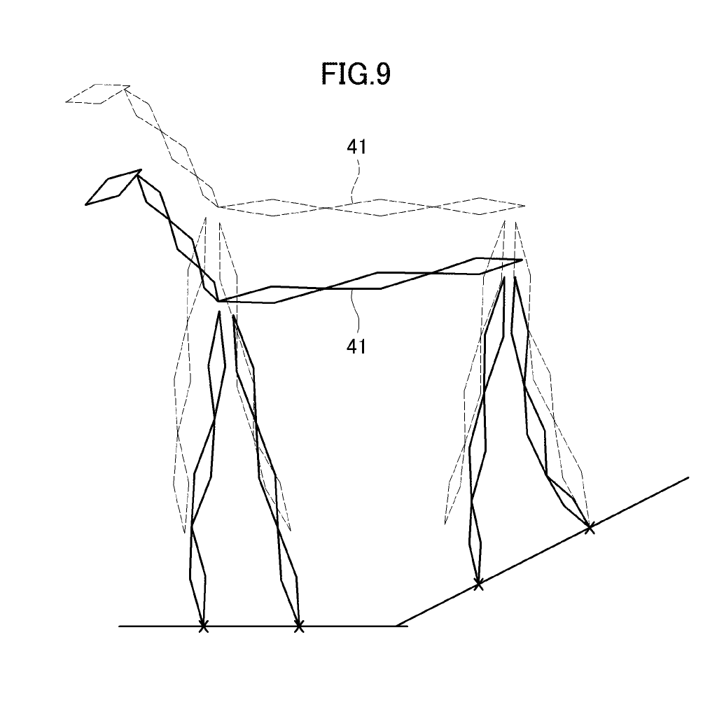

FIG. 9 is a diagram illustrating another example of a corrected arrangement of each of the skeletons 41. The type of motion is “walking” in this example, and this is an example in which the object is walking on a slope. Skeletons 41 represented by broken lines in FIG. 9 represent arrangements of the skeletons 41 before a correction which are stored in the motion data storing unit 23, and skeletons 41 represented by solid lines represent skeletons 41 corrected by the arrangement correction section 26. Cross marks in FIG. 9 represent positions which the feet touch are provided as parameters. In this example, the first partial correction section 31 carrying out “walking posture correction” first calculates arrangements (positions and directions) of skeletons 41 corresponding to the spine from foot touch positions provided as the parameters, and then the second partial correction section 31 carrying out the foot touch correction corrects positions of skeletons 41 corresponding to the feet.

The physical calculation section 28 is implemented mainly by the central control unit 11, the storing unit 12, and the arithmetic unit 13. The physical calculation section 28 carries out physical simulation (physical calculation) of a behavior of a ragdoll corresponding to each of the skeletons 41 based on the arrangements of the skeletons 41 corrected by the arrangement correction section 26 (Step S107). On this occasion, a position and a direction of the ragdoll before the physical calculation reflect the position and the direction of the corresponding skeleton 41. Then, the physical calculation section 28 determines the arrangement of the corresponding skeleton 41 in accordance with the calculated behavior of the ragdolls (Step S108). As a result, the arrangement of the skeleton 41 is further corrected so as to satisfy physical laws.

The image rendering section 29 is implemented mainly by the central control unit 11, the storing unit 12, and the arithmetic unit 13. The image rendering section 29 renders the image of the object 40 based on the arrangement of each of the skeletons 41 corrected by the physical calculation section 28 (Step S109). The image rendering section 29 first acquires vertex coordinates of skin meshes 42 based on the arrangement of each of the skeletons 41, and renders the acquired skin meshes 42, thereby rendering the image of the object 40.

The embodiment of the present invention is not limited to the one described above. For example, the arrangement of each of the skeletons 41 corrected by the physical calculation section 28 may be further corrected by the same function as the arrangement correction section 26, and the image rendering section 29 may render an image based on the corrected arrangements. As a result, even when a specific portion of the object 40 such as the head is displaced from a target position by influence of the gravity or the like as a result of the physical calculation, the specific portion can be aligned to the target position. Moreover, the parameter acquiring section 25 may acquire the parameter in accordance with a motion state of the partial correction section 31. For example, when a certain partial correction section 31 carries out a motion of looking back over a plurality of frames, it is possible to restrain, during the motion, a change in a parameter relating to a target value and reproduce a movement or the like after the motion of looking back has been completed.

The image generating device 1 generates an image more flexibly expressing a motion of an object through the above-mentioned processing. On this occasion, the partial correction sections 31 are provided for respective objects 40 and respective types of motions, and the number thereof is thus enormous. As described below, it is preferred that the partial correction section 31 be generated by an editing device.

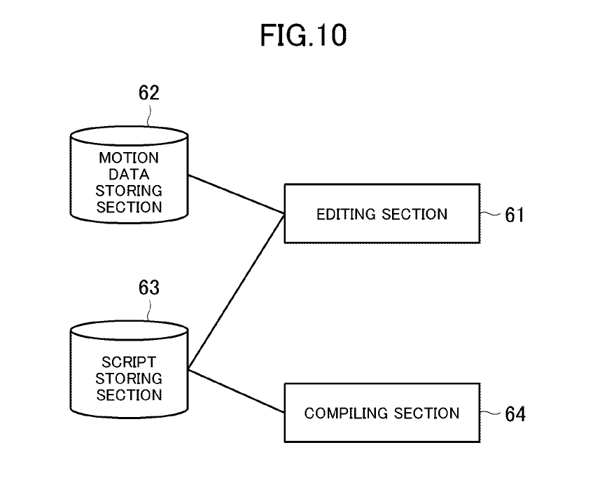

FIG. 10 is a diagram illustrating functional blocks of the editing device for generating motion data and the partial correction sections 31. The editing device functionally includes an editing section 61, a motion data storing section 62, a script storing section 63, and an executable form converting section 64. The editing device is also a computer including a central control unit and a storing unit as well as the image generating device 1.

The editing section 61 interactively edits information on the arrangement of the skeleton 41 and a script for correcting the arrangement of the skeleton 41. The editing section 61 may specifically be a function provided by a 3D modeling tool. The editing section 61 outputs the edited information on the arrangement of the skeleton 41 to the motion data storing section 62, and outputs the script to the script storing section 63. Note that, the editing section 61 servers to generate an image itself, and is not intended to operate in accordance with a real time input. Specifically, the editing section 61 does not provide a function of determining the state of the object 40 in accordance with an input of a user, or a function of dynamically combining scripts in accordance with the input of the user.

The executable form converting section 64 is implemented mainly by the central control unit and the storing unit. The executable form converting section 64 converts the script output by the editing section 61 into a program executable by the image generating device 1. The data for arrangement of skeletons 41, skin meshes 42 and ragdolls, and the like, which are generated by the editing section 61 and stored in the motion data storing section 62, and the executable program output from the executable form converting section 64 are provided for the image generating device 1. As a result, data and scripts created by the 3D modeling tool or the like can be migrated with low labor to the image generating device 1 for generating an image in accordance with a real time input or the like, and data to be used for generating the image can be efficiently prepared.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A computer-readable non-transitory information storage medium having stored thereon a program for controlling a computer to function as:
arrangement acquisition means for acquiring an arrangement of each of elements constituting an object with respect to a frame to be processed;
arrangement correction means for correcting the arrangement of each of the elements, the arrangement correction means including:
a plurality of partial correction means for respectively correcting the arrangement of at least one of the plurality of elements; and
control means for providing control based on control data associating a state of the object and at least two of the plurality of partial correction means and on the state of the object so that at least one of the plurality of partial correction means corrects the arrangement of each of the elements; and
image rendering means for rendering an image based on the arrangement of each of the elements corrected by the arrangement correction means.

2. The computer-readable non-transitory information storage medium having stored thereon a program according to claim 1, wherein:
the computer is further controlled to function as parameter acquisition means for acquiring at least one of a plurality of parameters corresponding to anyone of the plurality of the partial correction means based on a positional relationship between the object and another object; and
each of the plurality of partial correction means corrects at least one of the plurality of elements based on the acquired parameter corresponding to the partial correction means.

3. The computer-readable non-transitory information storage medium having stored thereon a program according to claim 2, wherein the parameter acquisition means acquires the parameter in accordance with the at least one of the plurality of partial correction means which the control means controls to correct the arrangement.

4. The computer-readable non-transitory information storage medium having stored thereon a program according to claim 2, wherein the parameter acquisition means acquires the parameter each time a frame to be processed changes.

5. An image generating device, comprising:
arrangement acquisition means for acquiring an arrangement of each of elements constituting an object with respect to a frame to be processed;
arrangement correction means including control means and a plurality of partial correction means, for correcting an arrangement of each of the elements;
storing means for storing control data associating a state of the object and at least two of the plurality of partial correction means with each other; and
image rendering means for rendering an image based on the arrangement of each of the elements corrected by the arrangement correction means, wherein:
the plurality of partial correction means respectively correct the arrangement of at least one of the plurality of elements; and
the control means provides control so that at least one of the plurality of partial correction means corrects the arrangement of each of the elements based on the control data and the state of the object.

6. An image generating method, comprising:
an arrangement acquisition step of acquiring an arrangement of each of elements constituting an object with respect to a frame to be processed;
an arrangement correction step including a control step and a plurality of partial correction steps to correct an arrangement of each of the elements; and
an image rendering step of rendering an image based on the arrangement of each of the elements corrected in the arrangement correction step, wherein:
the plurality of partial correction steps respectively comprise correcting the arrangement of at least one of the plurality of elements; and
the control step comprises providing control so that the arrangement of each of the elements is corrected in at least one of the plurality of partial correction steps based on control data, which associates a state of the object and at least two of the plurality of partial correction steps, and on the state of the object.
